(19) United States
(12) Patent Application Publication
(10) Pub. No.: US 2026/0229172 A1
(43) Pub. Date: Aug. 6, 2026

(54) DISPLAY MODULE AND DISPLAY APPARATUS HAVING SAME

(71) Applicant: SAMSUNG ELECTRONICS CO., LTD., Suwon-si (KR)

(72) Inventors: Youngki JUNG, Suwon-si (KR); Wonkeun PARK, Suwon-si (KR); Chulgyu JUNG, Suwon-si (KR); Jeongphil SEO, Suwon-si (KR); Seongphil CHO, Suwon-si (KR)

(73) Assignee: SAMSUNG ELECTRONICS CO., LTD., Suwon-si (KR)

(21) Appl. No.: 19/648,665

(22) Filed: Apr. 15, 2026

Related U.S. Application Data
(63) Continuation of application No. PCT/KR2024/015199, filed on Oct. 7, 2024.

(30) Foreign Application Priority Data
Nov. 30, 2023 (KR) 10-2023-0170880
Mar. 12, 2024 (KR) 10-2024-0034759

(51) Int. Cl. G09G 3/32

(52) U.S. Cl. CPC G09G 3/32; G09G 2300/0842; G09G 2320/0247; G09G 2330/021; G09G 2330/027

(57) ABSTRACT

A display module includes: a substrate; and a plurality of pixel circuits provided on the substrate, wherein each pixel circuit of the plurality of pixel circuits includes: a light-emitting diode (LED); a driving line including a driving thin film transistor (TFT) connected to an anode terminal of the LED and configured to apply a driving current; a sensing line including a sensing TFT connected to the anode terminal of the LED and configured to sense the driving current; and a variable power supply connected to a cathode terminal of the LED and configured to change a voltage supplied while the driving current is sensed.

### CROSS-REFERENCE TO RELATED APPLICATIONS

This application is a Continuation Application of International Application No. PCT/KR2024/015199 filed on October 7, 2024, which claims priority to Korean Patent Application No. 10-2023-01700880, filed on November 30, 2023, and Korean Patent Application No. 10-2024-0034759, filed on March 12, 2024, in the Korean Ministry of Intellectual Property, the disclosures of which are incorporated by reference herein in their entireties.

### BACKGROUND

### 1. Field

The present disclosure relates to a display module that implements images by using an inorganic light emitting device, and a display apparatus including the same.

### 2. Description of Related Art

In general, a display apparatus is a kind of output apparatus that converts acquired or stored electrical information into visual information to display the visual information for users. The display apparatus is widely used in various fields, such as home or places of business.

Display apparatuses are classified into self-emissive displays in which each pixel itself emits light and non-emissive displays utilizing separate light sources.

A liquid crystal display (LCD) is a representative non-emissive display and includes a backlight unit that supplies light from behind the display panel, a liquid crystal layer that acts as a switch to transmit/block light, a color filter that changes the supplied light to a desired color, etc. Therefore, the LCD is structurally complex and has limitations in implementing a thin thickness.

In contrast, a self-emissive display, which has a light-emitting device for each pixel to enable each pixel to itself emit light, does not require components such as a backlight unit and a liquid crystal layer and can also omit a color filter. Therefore, the self-emissive display is structurally simple and has a high degree of design freedom. In addition, the self-emissive display can not only achieve a thin thickness, but also achieve an excellent contrast ratio, brightness, and viewing angle.

Among such self-emissive displays, a micro light-emitting diode (LED) display is configured with a plurality of micro-sized LEDs. The micro-LED display provides an excellent contrast ratio, response time, and energy efficiency, compared to the LCD requiring the backlight.

Also, micro-LEDs which are inorganic light-emitting devices are brighter, have better luminous efficiency, and have a longer lifespan than organic LEDs (OLEDs) requiring separate encapsulation layers to protect organic materials.

Generally, micro-LED displays are made by connecting a plurality of display modules to form a display. In this case, it is necessary to accurately sense a thin film transistor (TFT) current flowing within the pixel circuits to compensate for the brightness deviation between the display modules.

### SUMMARY

Provided is a display module that may more accurately sensing a current by, while the current is sensed, preventing the current from flowing to a Light Emitting Diode(LED) and changing a reference voltage to prevent the LED from being turned on, and a display apparatus including the same.

Also, provided is a display module that may increase a user’s convenience by sensing a current within a blank time while a display screen operates or within a turning on/off time of a display, and a display apparatus including the same.

The technical aspects and objects intended to be achieved by the present disclosure are not limited to the above-mentioned technical aspects and objects, and other technical aspects and objects not mentioned will be clearly understood by one of ordinary skill in the technical art to which the present disclosure belongs from the following description.

According to an aspect of the disclosure, a display module includes: a substrate; and a plurality of pixel circuits provided on the substrate, wherein each pixel circuit of the plurality of pixel circuits includes: a light-emitting diode (LED); a driving line including a driving thin film transistor (TFT) connected to an anode terminal of the LED and configured to apply a driving current; a sensing line including a sensing TFT connected to the anode terminal of the LED and configured to sense the driving current; and a variable power supply connected to a cathode terminal of the LED and configured to change a voltage supplied while the driving current is sensed.

The variable power supply may be further configured to supply a voltage increased by a first voltage while the driving current is sensed.

The sensing TFT may be further configured to be turned on while the driving current is sensed.

The sensing TFT may be further configured to be turned on to sense the driving current within a blank time between a plurality of frames of an image output by the display module.

The sensing TFT may be further configured to be turned on to sense the driving current while a display panel of the display module is turned on or off.

The driving current may flow from the driving line to the sensing line while the driving current is sensed.

Each pixel circuit of the plurality of pixel circuits may further include a data line connected to the anode terminal of the LED and configured to receive a data signal, and the sensing line may be connected to a first node on the data line.

The driving current may flow from the driving line to the sensing line via the first node of the data line while the driving current is sensed.

According to an aspect of the disclosure, display apparatus includes: a frame; and a plurality of display modules arranged in a two-dimensional matrix on the frame, wherein each display module of the plurality of display modules includes: a substrate; and a plurality of pixel circuits provided on the substrate, and wherein each of the plurality of pixel circuits includes: a light-emitting diode (LED); a driving line including a driving thin film transistor (TFT) connected to an anode terminal of the LED and configured to apply a driving current; a sensing line including a sensing TFT connected to the anode terminal of the LED and configured to sense the driving current; and a variable power supply connected to a cathode terminal of the LED and configured to change a voltage supplied while the driving current is sensed.

The variable power supply may be further configured to supply a voltage increased by a first voltage while the driving current is sensed.

The sensing TFT may be further configured to be turned on while the driving current is sensed.

The sensing TFT may be further configured to be turned on to sense the driving current within a blank time between a plurality of frames of an image output by the display module.

The sensing TFT may be further configured to be turned on to sense the driving current while a display panel of the display module is turned on or off.

The driving current may flow from the driving line to the sensing line while the driving current is sensed.

Each pixel circuit of the plurality of pixel circuits may further include: a data line connected to the anode terminal of the LED and configured to receive a data signal, and wherein the sensing line is connected to a first node on the data line.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view showing an example of a display module and a display apparatus including the same, according to an embodiment of the present disclosure;

FIG. 2 is a diagram showing an example of a pixel array constituting a unit module of a display apparatus according to an embodiment of the present disclosure;

FIG. 3 is a block diagram of a display apparatus according to an embodiment of the present disclosure;

FIG. 4 is a block diagram illustrating a configuration of a display module included in a display apparatus according to an embodiment of the present disclosure;

FIG. 5 is a diagram for conceptually describing a method by which each pixel is driven in a display module according to an embodiment of the present disclosure;

FIG. 6 is a circuit diagram showing a pixel circuit for controlling a pixel in a display module according to an embodiment of the present disclosure;

FIG. 7 is a diagram showing a state in which a Light Emitting Diode is turned on while a current is sensed, according to an embodiment of the present disclosure;

FIG. 8 shows a change of a reference voltage supplied while a current is sensed, according to an embodiment of the present disclosure;

FIGS. 9, 10, 11, and 12 are diagrams showing various circuit structures for accurate current sensing, according to embodiments of the present disclosure; and

FIG. 13 shows a current sensing period according to an embodiment of the present disclosure.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

As used herein, the term “and/or” includes any and all combinations of one or more of associated listed items.

Terms such as “first”, “second”, or “1^{st}” or “2^{nd}” may be used simply to distinguish a component from other components, without limiting the component in other aspects (for example, importance or order).

Herein, describing that a certain (e.g., first) component is “coupled” or “connected” to another (for example, second) component, with or without the terms “functionally” or “communicatively,” means that the certain component can be connected to the other component directly (for example, by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that a certain component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when a certain component is referred to as being “on” or “over” another component, it can be directly on the other component or intervening components may also be present.

Hereinafter, embodiments of the present disclosure will be described with reference to the accompanying drawings.

Throughout this specification, like reference numerals will refer to like components. This specification does not describe all components of the embodiments, and general information in the technical field to which the disclosure belongs or overlapping information between the embodiments will not be described. As used herein, the terms “portion”, “part”, “module”, “member” or “block” may be implemented as software or hardware, and according to embodiments, a plurality of “portions”, “parts”, “modules”, “members” or “blocks” may be implemented as a single component, or a single “portion”, “part”, “module”, “member” or “block” may include a plurality of components.

It will be understood that when a certain part is referred to as being “connected” to another part, it can be directly or indirectly connected to the other part. When a part is indirectly connected to another part, it may be connected to the other part through a wireless communication network or electrically by wiring, soldering, etc.

Also, it will be understood that when a certain part “includes” a certain component, the part does not exclude another component but can further include another component, unless the context clearly dictates otherwise.

In the entire specification, it will also be understood that when an element is referred to as being “on” or “over” another element, it can be directly on the other element or intervening elements may also be present.

In the entire specification, it will also be understood that when a certain component transfers or transmits a signal or data to another component, a case in which another component is present between the corresponding component and the other component and the corresponding component transfers or transmits the signal or data through the other component is not exclusive, unless the context clearly dictates otherwise.

Herein, the ordinal terms “first”, “second”, etc. are used to distinguish a plurality of components from each other, without representing an arrangement order of the components, a manufacturing order of the components, importance of the components, etc.

It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

When the expression such as “at least one” precedes a list of components, the expression may modify a combination of the components. For example, the expression “at least one of a, b or c” can be interpreted to include only a, only b, only c, both a and b, both a and c, both b and c, or all of a, b, and c.

Hereinafter, a display module and a display apparatus including the same according to an aspect will be described in detail with reference to the accompanying drawings.

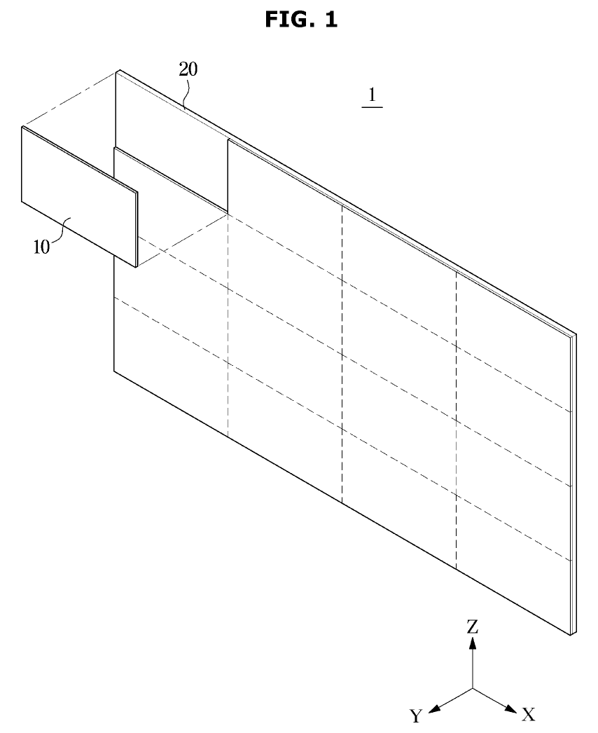

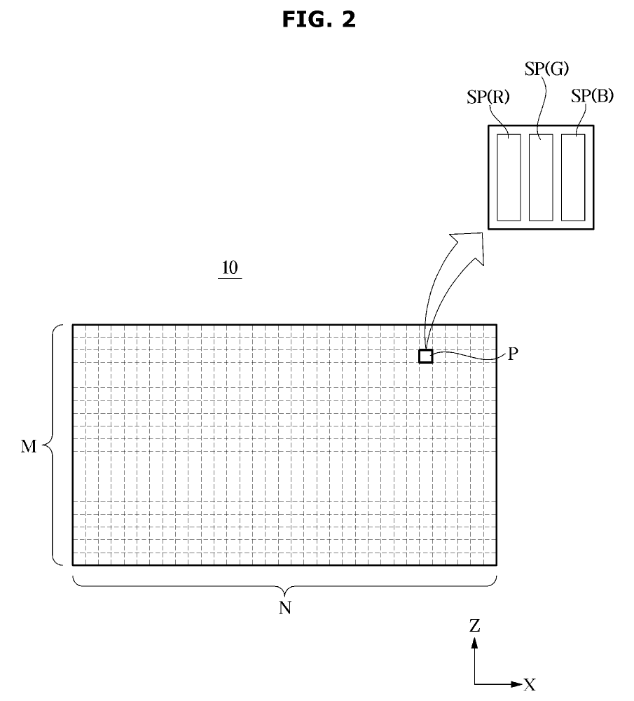

FIG. 1 is a perspective view showing an example of a display module and a display apparatus including the same, according to an embodiment of the present disclosure, and FIG. 2 is a diagram showing an example of a pixel array constituting a unit module of a display apparatus according to an embodiment of the present disclosure.

A display apparatus 1 according to an embodiment may be a self-emissive display apparatus in which a light-emitting device is positioned for each pixel to enable each pixel to itself emit light. Therefore, because the display apparatus does not require components such as a backlight unit or a liquid crystal layer, unlike a liquid crystal display apparatus, the display apparatus may implement a thin thickness and be structurally simple to allow various design changes.

Also, the display apparatus according to an embodiment may adopt an inorganic light-emitting device such as an inorganic light emitting diode as a light-emitting device positioned for each pixel. Inorganic light emitting devices may have a faster response speed than organic light-emitting devices such as OLEDs and implement high brightness with low power consumption.

In addition, unlike the organic light-emitting devices that require an encapsulation process and have low durability due to vulnerability to moisture and oxygen exposure, the inorganic light-emitting devices do not require an encapsulation process and have high durability. Hereinafter, an inorganic light-emitting device mentioned in the following embodiments refers to an inorganic light-emitting diode.

The inorganic light-emitting device employed in the display apparatus according to an embodiment may be a micro-LED display having a short side length of about 100 μm, about tens of μm, or about several μm. As such, by employing micro-scale LEDs, a pixel size may be reduced and high resolution may be implemented within the same screen size.

Also, by manufacturing LED chips in micro-scale sizes, a problem of inorganic materials breaking when bent may be resolved. In other words, in a case where micro LED chips are mounted on a flexible substrate, the LED chips will not break even when the substrate is bent, which may make it possible to implement a flexible display apparatus.

A display apparatus employing micro LEDs may be applied to various fields by taking advantage of an ultra-small pixel size and thin thickness. For example, as shown in FIG. 1, a large-area screen may be implemented by tiling a plurality of display modules 10 on which a plurality of micro LEDs are mounted and fixing the display modules 10 to a housing 20, and a display apparatus having such a large-area screen may be used as a signage, a billboard, etc.

A three-dimensional coordinate system of XYZ axes shown in FIG. 1 may be based on the display apparatus 1, and a plane on which a screen of the display apparatus 1 is located may be an XZ plane, and a direction in which images are output or a light-emitting direction of the inorganic light-emitting device may be a +Y direction. Because the coordinate system is based on the display apparatus 1, the same coordinate system may be applied to both a case where the display apparatus 1 is lying and a case where the display apparatus 1 stands.

Generally, because the display apparatus 1 is used in a standing state, and a user views images in front of the display apparatus 1, the +Y direction in which images are output may be referred to as a front direction and the opposite direction may be referred to as a rear direction.

Also, the display apparatus 1 may be generally manufactured in a lying state. Therefore, a -Y direction of the display apparatus 1 may be referred to as ae downward direction and the +Y direction may be referred to as an upward direction. That is, in the following embodiment, the +Y direction may be referred to as an upward direction or a front direction, and the -Y direction may be referred to as a downward direction or a rear direction.

Except for upper and lower surfaces of the display apparatus 1 or the display module 10 which is a flat type, the remaining four surfaces may be all referred to as side surfaces regardless of a position of the display apparatus 1 or the display module 10.

In an example of FIG. 1, a case where the display apparatus 1 includes a plurality of display modules to implement a large-area screen is shown. However, embodiments of the display apparatus 1 are not limited thereto. The display apparatus 1 may include a single display module 10 and be implemented as a television (TV), a wearable device, a portable device, a monitor for personal computer (PC), etc.

Referring to FIG. 2, the display module 10 may include a M x N (M and N are integers greater than or equal to 2) array of pixels, that is, a plurality of pixels arranged two-dimensionally. FIG. 2 conceptually shows a pixel array and the display module 10 may include, in addition to active areas where pixels are arranged, bezel areas, wiring areas, etc., where no image is displayed.

In the present embodiment, a case where certain components are arranged two-dimensionally may include not only a case where the components are arranged on the same plane, but also a case where the components are arranged on different planes that are parallel to each other. In addition, the case where the components are arranged on the same plane may not necessarily require that tops of the arranged components are located on the same plane and may also include a case where the tops of the arranged components are located on different planes that are parallel to the plane.

Each unit pixel P may include at least three sub pixels that output different colors of light. For example, the unit pixel P may be configured with three sub pixels SP(R), SP(G), and SP(B) respectively corresponding to R, G, and B. Here, a red sub pixel SP(R) may output red light, a green sub pixel SP(G) may output green light, and a blue sub pixel SP(B) may output blue light.

However, the pixel array of FIG. 2 is only an example that may be applied to the display module 10 and the display apparatus 1 according to an embodiment. The sub pixels may be arranged along a Z axis, may not be aligned, or may have different sizes. One pixel may only need to include a plurality of sub pixels to implement various colors, and there may be no restrictions on sizes or arrangement of the sub pixels.

Also, the pixel P may not need to be configured with the red sub pixel SP(R) that outputs red light, the green sub pixel SP(G) that outputs green light, and the blue sub pixel SP(B) that outputs blue light, and may include a sub pixel that outputs yellow light or white light. That is, there may be no restrictions on colors or kinds of light output from each sub pixel and the number of the sub pixels.

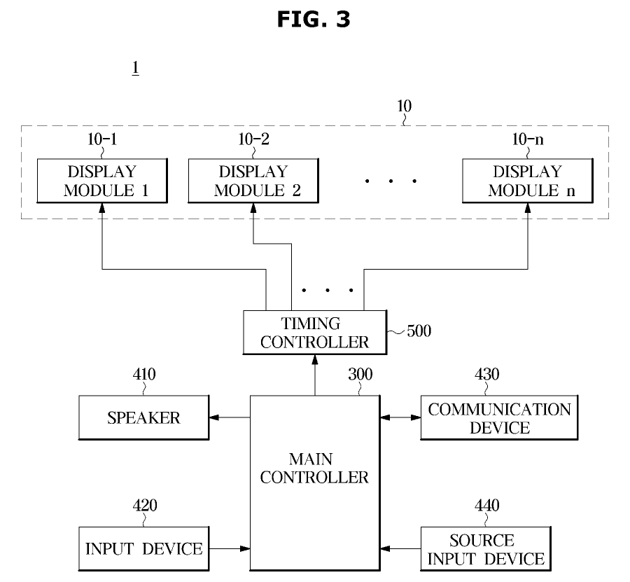

FIG. 3 is a block diagram of a display apparatus according to an embodiment of the present disclosure.

As described above with reference to FIG. 1, the display apparatus 1 according to an embodiment may include a plurality of display modules (10-1, 10-2, …, 10-n, wherein n is an integer greater than or equal to 2, a main controller 300 and a timing controller 500 that control the plurality of display modules 10, a communication device 430 that communicates with an external device, a source input device 440 that receives a source image, a speaker 410 that outputs a sound, and an input device 420 that receives a command for controlling the display apparatus 1 from a user.

The input device 420 may include a button(s) or touch pad provided on one area of the display apparatus 1, and in a case where the display apparatus 1 is implemented as a touch screen, the input device 420 may include a touch pad provided on a front side of the display apparatus 1. Also, the input device 420 may include a remote controller.

The input device 420 may receive various commands from a user to control the display apparatus 1, such as turning-on/off of the display apparatus 1, volume adjustment, channel adjustment, screen adjustment, and various settings adjustment.

The speaker 410 may be provided on one area of a main body 20 or may further include a separate speaker module physically separated from the main body 20.

The communication device 430 may communicate with a relay server or another electronic device to transmit and receive necessary data. The communication device 430 may adopt at least one of various wireless communication methods, such as 3rd Generation (3G), 4th Generation (4G), Wireless LAN, Wireless-Fidelity Wi-Fi, Bluetooth, Zigbee, Wi-Fi Direct (WFD), Ultra wideband (UWB), Infrared Data Association (IrDA), Bluetooth Low Energy (BLE), Near Field Communication (NFC), and Z-Wave. In addition, it may also be possible to adopt a wired communication method, such as Peripheral Component Interconnect (PCI), PCI-express, and Universal Serial Bus (USB).

The source input device 440 may receive a source signal from a set-top box, a USB, an antenna, etc. Accordingly, the source input device 440 may include at least one selected from a group of source input interfaces including a High Definition Multimedia Interface (HDMI) cable port, a USB port, an antenna, etc.

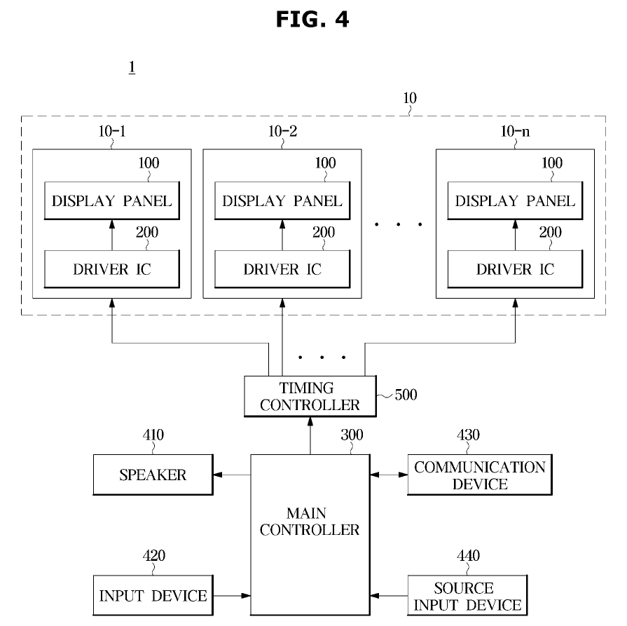

A source signal received by the source input device 440 may be processed by the main controller 300 and converted into a format capable of being output from a display panel 100 (see FIG. 4) and the speaker 410.

The main controller 300 and the timing controller 500 may include at least one memory that stores one or more programs, including instructions, and various data for performing operations which will be described below and at least one processor that executes the stored program.

The main controller 300 may process the source signal received through the source input device 440 to generate an image signal corresponding to the source signal.

For example, the main controller 300 may include a source decoder, a scaler, an image enhancer, and a graphics processor. The source decoder may decode the source signal compressed in a format such as Moving Picture Experts Group (MPEG), and the scaler may output image data of a desired resolution through resolution conversion.

The image enhancer may improve image quality of the image data by applying various correction techniques. The graphics processor may divide pixels of the image data into RGB data and output the RGB data together with a control signal such as a syncing signal for display timing of the display panel 100. That is, the main controller 300 may output the control signal and the image data corresponding to the source signal.

The above-described operations of the main controller 300 are only an example that may be applied to the display apparatus 1, and the main controller 300 may further perform other operations or omit some of the above-described operations.

The image data and the control signal output from the main controller 300 may be transferred to the timing controller 500.

The timing controller 500 may convert the image data transferred from the main controller 300 into image data having a format capable of being processed by a driver integrated circuit (IC) 200 (see FIG. 4) and generate various control signals such as a timing control signal required to display the image data on the display panel 100.

Although the display apparatus 1 according to an embodiment does not necessarily have to include the plurality of display modules 10, in the following embodiment, for detailed description, an operation of each component will be described in detail in an example of the display apparatus 1 including the plurality of display modules 10.

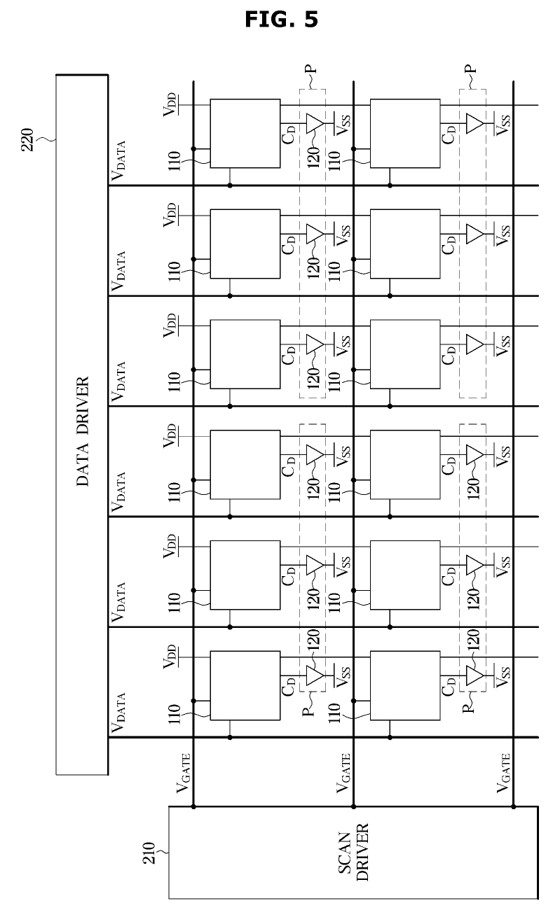

FIG. 4 is a block diagram illustrating a configuration of a display module included in a display apparatus according to an embodiment of the present disclosure, and FIG. 5 is a diagram for conceptually describing a method by which each pixel is driven in a display module according to an embodiment of the present disclosure.

Referring to FIG. 4, each of the plurality of display modules 10-1, 10-2, …, 10-n may include the display panel 100 that displays an image and the driver IC 200 that drives the display panel 100.

The driver IC 200 may generate a driving signal for the display panel 100 to display an image based on image data and a timing control signal transferred from the timing controller 500.

The driving signal generated by the driver IC 200 may include a gate signal and a data signal, and the generated driving signal may be input to the display panel 100.

As described above, the display apparatus 1 according to an embodiment may be a self-emissive display device. Accordingly, an inorganic light-emitting device 120 that emits red light, green light, or blue light may be positioned in each sub pixel.

The inorganic light-emitting device 120 positioned in each sub pixel may be driven by an active matrix (AM) method or a passive matrix (PM) method. However, in the following embodiment, for detailed description, a case where the inorganic light-emitting device 120 is driven by the AM method will be described as an example.

Referring to FIG. 5, the driver IC 200 may include a scan driver 210 and a data driver 220. The scan driver 210 may output a gate signal for turning on/off a sub pixel, and the data driver 220 may output a data signal for implementing an image.

The scan driver 210 may generate a gate signal based on the timing control signal transferred from the timing controller 500, and the data driver 220 may generate a data signal based on the image data transferred from the timing controller 500.

The display module 10 may include a pixel circuit 110 for independently controlling each inorganic light-emitting device 120, and the gate signal output from the scan driver 210 and the data signal output from the data driver 220 may be input to the pixel circuit 110.

For example, according to a gate voltage VGATE, a data voltage VDATA, and a supply voltage VDD being input to the pixel circuit 110, the pixel circuit 110 may output a driving current CD for driving the inorganic light-emitting device 120.

The driving current CD output from the pixel circuit 110 may be input to the inorganic light-emitting device 120, and the inorganic light-emitting device 120 may emit light by the input driving current CD to implement an image.

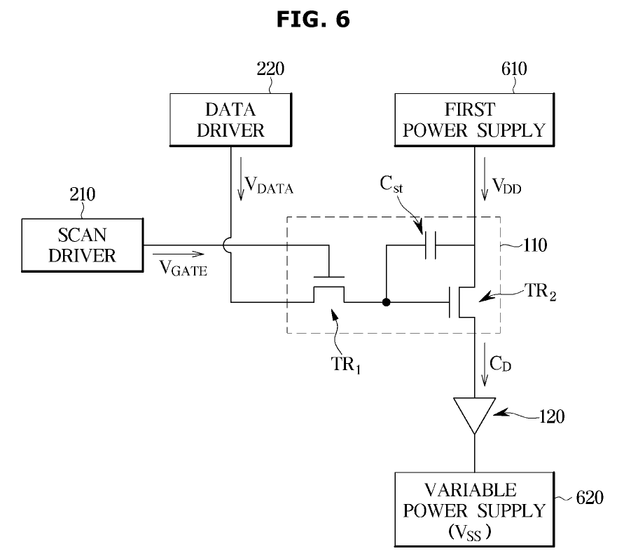

FIG. 6 is a circuit diagram showing a pixel circuit for controlling a sub pixel in a display module according to an embodiment of the present disclosure.

Referring to an example of FIG. 6, a pixel circuit 110 may include a capacitor Cst and thin film transistors TR1 and TR2 for switching or driving an inorganic light-emitting device 120.

For example, the thin film transistors TR1 and TR2 may include a switching transistor TR1 and a driving transistor TR2, and the switching transistor TR1 and the driving transistor TR2 may be implemented as PMOS type transistors. However, embodiments of the display module 10 and the display apparatus 1 are not limited thereto, and the switching transistor TR1 and the driving transistor TR2 may be implemented as NMOS type transistors.

Also, the thin film transistors TR1 and TR2 may be Low Temperature Polycrystalline Silicon (LTPS) thin film transistors or Oxide thin film transistors. Also, the thin film transistors may be a-Si thin film transistors or single crystal thin film transistors.

For detailed description, in the following embodiment, a case where the thin film transistors TR1 and TR2 are implemented as LTPS PMOS type transistors will be described as an example.

A gate electrode of the switching transistor TR1 may be connected to the scan driver 210, a source electrode thereof may be connected to the data driver 220, and a drain electrode thereof may be connected to one end of the capacitor Cst and a gate electrode of the driving transistor TR2. Another end of the capacitor Cst may be connected to a first power supply 610.

Also, a source electrode of the driving transistor TR2 may be connected to the first power supply 610 that supplies a supply voltage VDD and a drain electrode thereof may be connected to an anode of the inorganic light-emitting device 120.

A cathode of the inorganic light-emitting device 120 may be connected to a variable power supply 620 that supplies a reference voltage VSS. The reference voltage VSS may be a voltage having a lower level than the supply voltage VDD and use a ground voltage, etc. to provide a ground.

Here, the power supply 620 may adjust a reference voltage that is supplied, which will be described below.

The pixel circuit 110 having the above-described structure may operate as follows. First, when a gate voltage VGATE is applied from the scan driver 210 and thus the switching transistor TR1 is turned on, a data voltage VDATA applied from the data driver 220 may be transferred to one end of the capacitor Cst and the gate electrode of the driving transistor TR2.

A voltage corresponding to a gate-source voltage of the driving transistor TR2 may be maintained for a preset time by the capacitor Cst. The driving transistor TR2 may apply a driving current CD corresponding to the gate-source voltage to the anode of the inorganic light-emitting device 120 to cause the inorganic light-emitting device 120 to emit light.

However, the above-described structure of the pixel circuit 110 is only an example that may be applied to the display module 10 according to an embodiment, and various circuit structures for switching and driving a plurality of inorganic light-emitting devices 120 may be applied in addition to the above-described example.

Also, in the present embodiment, there are no restrictions on a method of controlling brightness of the inorganic light-emitting device 120. The brightness of the inorganic light-emitting device 120 may be controlled by one of various methods, such as a pulse amplitude modulation (PAM) method, a pulse width modulation (PWM) method, and a hybrid method as a combination of the PAM method and the PWM method, and the structure of the pixel circuit 110 may also vary depending on a brightness control method.

So far, an overall structure and operations of the pixel circuit 110 have been described. Hereinafter, operations for sensing a current within the pixel circuit 110 will be described.

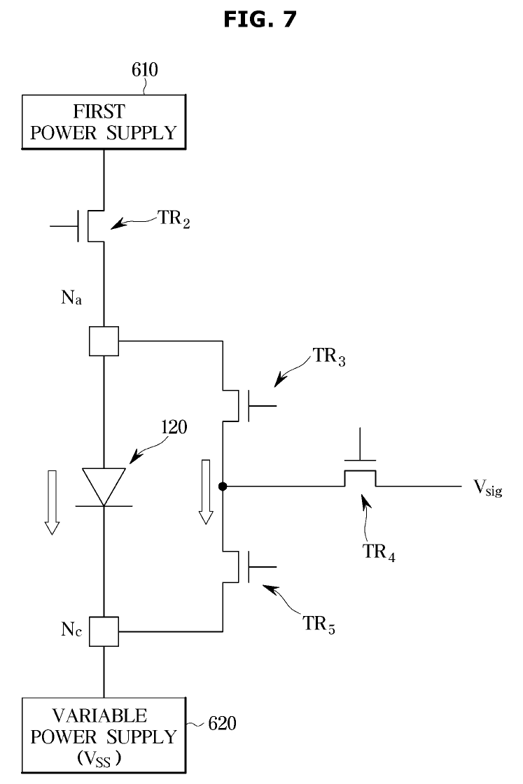

FIG. 7 is a diagram showing a state in which an LED is turned on while a current is sensed, according to an embodiment of the present disclosure.

To compensate for brightness deviation between display modules, a minimum aging time and a TFT current may need to be accurately sensed. To accurately sense a TFT current, it may be needed to prevent a current from flowing to an LED 120 by completely turning off the LED 120.

In a case where a test transistor TR3 is provided to sense a current generated in a driving TFT (TR2), when a current flows to the test transistor TR3 for sensing a current, the current may also flow to an LED having similar resistance.

That is, when the LED is in an on state, a current flowing to the test transistor TR3 may be distributed due to a current flowing to the LED, which may make it difficult to accurately sense a driving TFT current.

Accordingly, to cause a voltage applied to the LED to be lower than a turn-on voltage and prevent a current from flowing to the LED, a circuit structure may need to change.

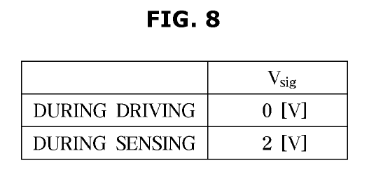

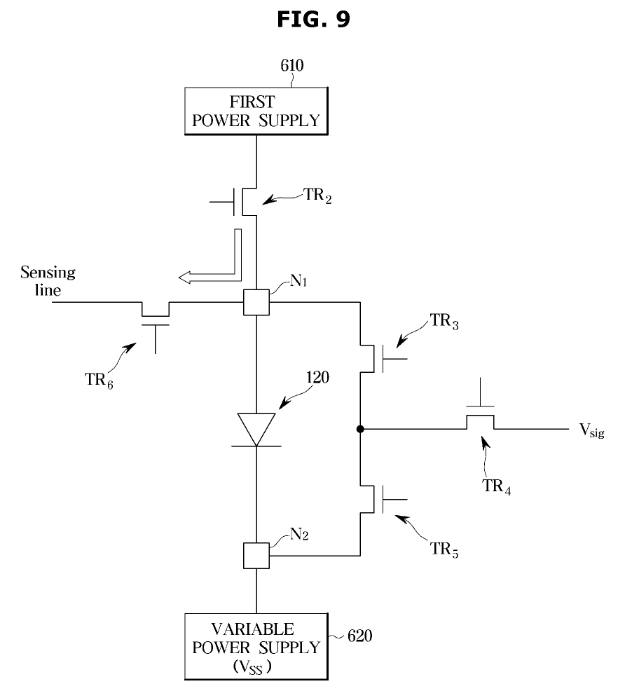

FIG. 8 shows a change of a reference voltage supplied while a current is sensed, according to an embodiment of the present disclosure, and FIG. 9 is a diagram showing a circuit structure for accurate current sensing, according to an embodiment of the present disclosure.

The display module 10 according to the present disclosure may include a plurality of pixel circuits 110 provided on a substrate, and each of the plurality of pixel circuits 110 may include a driving line including a driving TFT TR2 connected to an anode terminal of an LED 120 to apply a driving current, a sensing line including a sensing TFT TR6 connected to the anode terminal of the LED 120 to sense the driving current, and a variable power supply 620 connected to a cathode terminal of the LED 120 to change a voltage supplied while the driving current is sensed.

The sensing TFT TR6 may be turned on while the driving current is sensed. Therefore, while the driving current is sensed, the driving current may flow from the driving line to the sensing line.

A demux TFT TR4 may receive a data signal from Vsig and distribute the signal. While the driving signal is sensed, the demux TFT TR4 may be turned off.

While the driving signal is sensed, a voltage applied to the LED 120 may need to be reduced to prevent the LED 120 from being turned on.

To this end, the variable power supply 620 may increase a voltage supplied while the driving current is sensed, by a first voltage. Here, the first voltage may be set to an appropriate value for turning off the LED 120 while the driving current is sensed, and for example, the first voltage may be about 2 V in consideration of a turn-on voltage of the LED 120.

That is, as shown in FIG. 8, the reference voltage may be 0 V while the display operates, and while a driving current is sensed, the variable power supply may control a voltage to be supplied such that the reference voltage becomes 2 V.

Through this control, while a driving current is sensed, the LED may not be turned on. By, while a driving current is sensed, turning off the test TFT TR3 and the demux TFT TR4 and turning on the sensing TFT TR6, the driving current may flow from the driving line toward the sensing TFT TR6 switched on via the anode terminal of the LED 120. Accordingly, an accurate driving current that has not been distributed to the LED may be sensed.

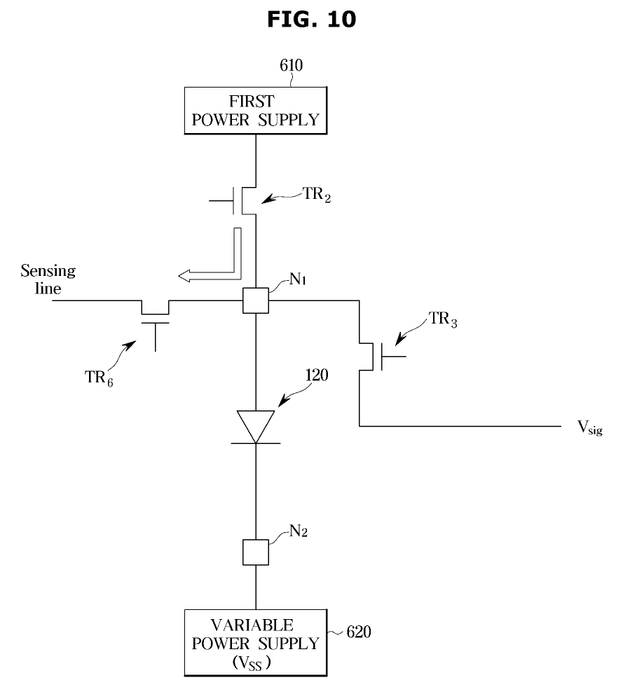

FIGS. 10, 11 and 12 are diagrams showing various circuit structures for accurate current sensing, according to embodiments of the present disclosure.

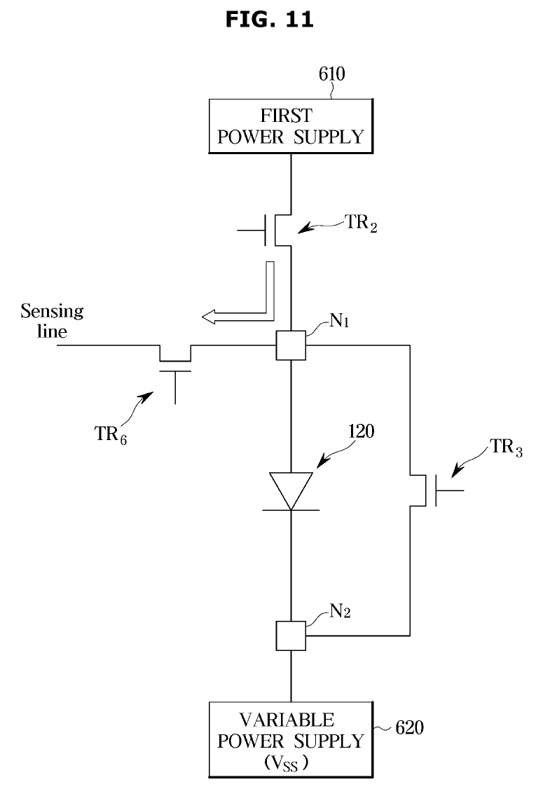

Referring to FIGS. 10 and 11, a driving line including a driving TFT TR2 connected to an anode terminal of an LED 120 to apply a driving current, a sensing line including a sensing TFT TR6 connected to the anode terminal of the LED to sense the driving current, and a variable power supply 620 connected to a cathode terminal of the LED 120 to change a voltage supplied while the driving current is sensed may be included.

The variable power supply 620 may increase a voltage supplied while a driving current is sensed, by a first voltage. As described above, the first voltage may be about 2 V in consideration of a turn-on voltage of the LED 120.

Through this control, while a driving current is sensed, the LED 120 may not be turned on. While a driving current is sensed, by turning off a test TFT TR3 and turning on the sensing TFT TR6, the driving current may flow from the driving line toward the sensing TFT TR6 switched on via the anode terminal of the LED. Accordingly, an accurate driving current that has not been distributed to the LED may be sensed.

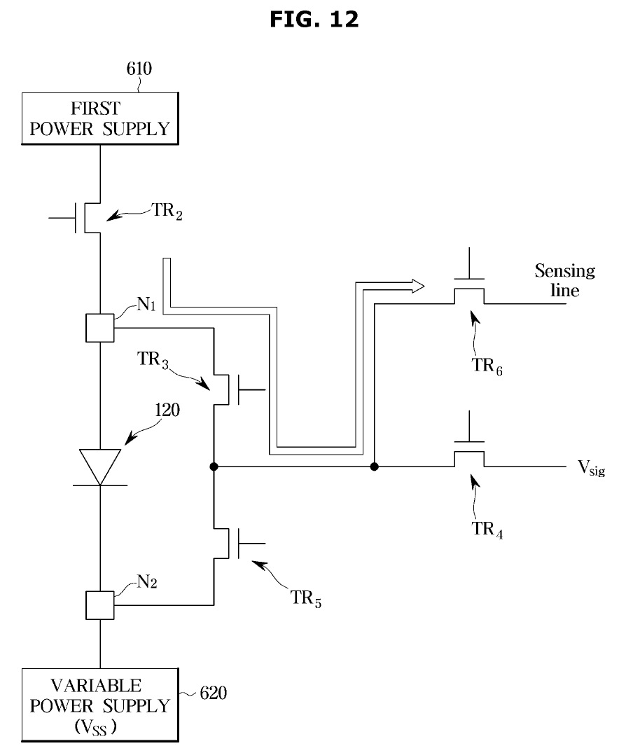

Referring to FIG. 12, a sensing line may be connected to a data line connected to an anode terminal of an LED 120 to receive a data signal.

That is, in cases of FIGS. 9, 10, and 11, a separate sensing line may be connected to each LED, while the sensing line of FIG. 12 may be connected to each data line to thereby minimize a change of an existing pixel circuit.

The variable power supply 620 may increase a voltage supplied while a driving current is sensed, by a first voltage.

Through this control, while a driving current is sensed, the LED 120 may not be turned on. By, while a driving current is sensed, turning off the demux TR4 and the TFT TR5 and turning on the test TFT TR3 and the sensing TFT TR6, the driving current may flow from the driving line toward the sensing TFT TR6 switched on via the anode terminal of the LED and the test TFT TR3 switched on. Accordingly, an accurate driving current that has not been distributed to the LED 120 may be sensed.

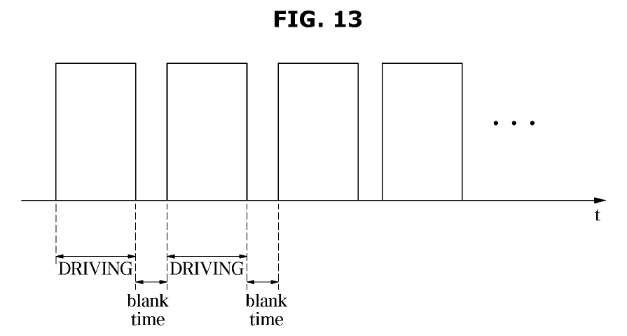

FIG. 13 shows a current sensing period according to an embodiment of the present disclosure.

A driving current may be sensed within a blank time between frames of an image output from the display or within a loading time for which the display is turned on or off.

That is, the sensing TFT TR6 may be turned on while the display is turned on or off, or the sensing TFT TR6 may be turned on in a blank time between a plurality of frames of an image output from the display.

A driving current may be sensed while a screen is not actually driven, and while the driving current is sensed, the LED may not be turned on to maintain a black screen of the display, thereby increasing a user’s convenience.

A display module according to an embodiment may include: a substrate; and a plurality of pixel circuits provided on the substrate, and each of the plurality of pixel circuits may include: an LED; a driving line including a driving TFT connected to an anode terminal of the LED and configured to apply a driving current; a sensing line including a sensing TFT connected to the anode terminal of the LED and configured to sense the driving current; and a variable power supply connected to a cathode terminal of the LED and configured to change a voltage supplied while the driving current is sensed.

According to the present disclosure, by, while a current is sensed, preventing the current from flowing to the LED and changing a reference voltage to prevent the LED from being turned on, the current may be more accurately sensed.

The variable power supply may be configured to supply a voltage increased by a first voltage while the driving current is sensed.

The sensing TFT may be configured to be turned on while the driving current is sensed.

The sensing TFT may be configured to be turned on to sense the driving current within a blank time between a plurality of frames of an image output from the display.

The sensing TFT may be configured to be turned on to sense the driving current while the display is turned on or off.

According to the present disclosure, by sensing a current within a blank time while a display screen is driven or within a turning-on/off time of the display, a user’s convenience may increase.

The driving current may flow from the driving line to the sensing line while the driving current is sensed.

Each of the plurality of pixel circuits may further include a data line connected to an anode terminal of the LED and configured to receive a data signal, and the sensing line may be connected to a first node on the data line.

The driving current may flow from the driving line to the sensing line via the first node of the data line while the driving current is sensed.

A display apparatus according to an embodiment may include: a frame; and a plurality of display modules arranged in a two-dimensional matrix on the frame, each of the plurality of display modules may include: a substrate; and a plurality of pixel circuits provided on the substrate, and each of the plurality of pixel circuits may include: an LED; a driving line including a driving TFT connected to an anode terminal of the LED and configured to apply a driving current; a sensing line including a driving TFT connected to the anode terminal of the LED and configured to sense the driving current; and a variable power supply connected to a cathode terminal of the LED and configured to change a voltage supplied while the driving current is sensed.

The variable power supply may be configured to supply a voltage increased by a first voltage while the driving current is sensed.

The sensing TFT may be configured to be turned on while the driving current is sensed.

The sensing TFT may be configured to be turned on to sense the driving current within a blank time between a plurality of frames of an image output from the display.

The sensing TFT may be configured to be turned on to sense the driving current while the display is turned on or off.

The driving current may flow from the driving line to the sensing line while the driving current is sensed.

Each of the plurality of pixel circuits may further include a data line connected to the anode terminal of the LED and configured to receive a data signal, and the sensing line may be connected to a first node on the data line.

The driving current may flow from the driving line to the sensing line via the first node of the data line while the driving current is sensed.

According to one or more embodiments of the disclosure, by preventing the current from flowing to the LED and changing a reference voltage to prevent the LED from being turned on, while a current is sensed, the current may be more accurately sensed.

Also, according to one or more embodiments of the disclosure, by sensing a current within a blank time while a display screen operates or within a turning on/off time of the display, a user’s convenience may increase.

Embodiments of the disclosure may be implemented in the form of a non-transitory recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include various kinds of recording media storing instructions that can be interpreted by a computer. For example, the computer-readable recording medium may be read-only memory (ROM), random-access memory (RAM), a magnetic tape, a magnetic disc, a flash memory, an optical data storage device, etc.

Certain example embodiments have been described with reference to the accompanying drawings. It will be understood by one of ordinary skill in the art to which the present disclosure belongs that the present disclosure can be implemented in different forms from the described embodiments without changing the technical spirit or essential features of the present disclosure. Thus, it should be understood that the described embodiments are merely for illustrative purposes and not for limitation purposes.

What is claimed is:

1. A display module comprising:
a substrate; and
a plurality of pixel circuits provided on the substrate,
wherein each pixel circuit of the plurality of pixel circuits comprises:
a light-emitting diode (LED);
a driving line comprising a driving thin film transistor (TFT) connected to an anode terminal of the LED and configured to apply a driving current;
a sensing line comprising a sensing TFT connected to the anode terminal of the LED and configured to sense the driving current; and
a variable power supply connected to a cathode terminal of the LED and configured to change a voltage supplied while the driving current is sensed.

2. The display module of claim 1, wherein the variable power supply is further configured to supply a voltage increased by a first voltage while the driving current is sensed.

3. The display module of claim 1, wherein the sensing TFT is further configured to be turned on while the driving current is sensed.

4. The display module of claim 3, wherein the sensing TFT is further configured to be turned on to sense the driving current within a blank time between a plurality of frames of an image output by the display module.

5. The display module of claim 3, wherein the sensing TFT is further configured to be turned on to sense the driving current while a display panel of the display module is turned on or off.

6. The display module of claim 1, wherein the driving current flows from the driving line to the sensing line while the driving current is sensed.

7. The display module of claim 1, wherein each pixel circuit of the plurality of pixel circuits further comprises a data line connected to the anode terminal of the LED and configured to receive a data signal, and
wherein the sensing line is connected to a first node on the data line.

8. The display module of claim 7, wherein the driving current flows from the driving line to the sensing line via the first node of the data line while the driving current is sensed.

9. A display apparatus comprising:
a frame; and
a plurality of display modules arranged in a two-dimensional matrix on the frame,
wherein each display module of the plurality of display modules comprises:
a substrate; and
a plurality of pixel circuits provided on the substrate, and
wherein each of the plurality of pixel circuits comprises:
a light-emitting diode (LED);
a driving line comprising a driving thin film transistor (TFT) connected to an anode terminal of the LED and configured to apply a driving current;
a sensing line comprising a sensing TFT connected to the anode terminal of the LED and configured to sense the driving current; and
a variable power supply connected to a cathode terminal of the LED and configured to change a voltage supplied while the driving current is sensed.

10. The display apparatus of claim 9, wherein the variable power supply is further configured to supply a voltage increased by a first voltage while the driving current is sensed.

11. The display apparatus of claim 9, wherein the sensing TFT is further configured to be turned on while the driving current is sensed.

12. The display apparatus of claim 11, wherein the sensing TFT is further configured to be turned on to sense the driving current within a blank time between a plurality of frames of an image output by the display module.

13. The display apparatus of claim 11, wherein the sensing TFT is further configured to be turned on to sense the driving current while a display panel of the display module is turned on or off.

14. The display apparatus of claim 9, wherein the driving current flows from the driving line to the sensing line while the driving current is sensed.

15. The display apparatus of claim 9, wherein each pixel circuit of the plurality of pixel circuits further comprises:
a data line connected to the anode terminal of the LED and configured to receive a data signal, and
wherein the sensing line is connected to a first node on the data line.
